(19) United States
(12) Patent Application Publication
(10) Pub. No.: US 2018/0227763 A1
(43) Pub. Date: Aug. 9, 2018

(54) INTERNET CONNECTION DEVICE, CENTRAL MANAGEMENT SERVER, AND INTERNET CONNECTION METHOD

(71) Applicant: KT Corporation, Seongnam-si, Gyeonggi-do (KR)

(72) Inventors: Tae Gyun KIM, Seongnam-si (KR); Bong Kwon KANG, Uiwang-si (KR); Deok Moon CHANG, Seoul (KR); Daesung CHO, Seoul (KR)

(73) Assignee: KT Corporation, Seongnam-si, Gyeonggi-do (KR)

(21) Appl. No.: 15/752,488

(22) PCT Filed: Aug. 12, 2016
(86) PCT No.: PCT/KR2016/008893

§ 371 Date: Feb. 13, 2018

(30) Foreign Application Priority Data
Aug. 13, 2015 (KR) 10-2015-0114948

(51) Int. Cl. H04W 12/12; H04L 29/12; H04L 29/06; H04W 12/08

(52) U.S. Cl. CPC H04W 12/12; H04L 61/1511; H04L 63/0428; H04W 12/08; H04L 63/0876

(57) ABSTRACT

A network connecting device, a central management server, and a network connecting method. The network connecting device is a network connecting device connected to a user terminal and a network, and it includes: a forgery and falsification detector which changes a destination IP address of a domain name server (DNS) query received from the user terminal with an IP address of a DNS that is known in advance and is reliable; and a network connector which transmits a DNS query including an IP address of the reliable DNS to the network.

### CROSS-REFERENCE TO RELATED APPLICATIONS

This application is a U.S. National Stage application under 35 U.S.C. § 371 of International Application No. PCT/KR2016/008893, filed on Aug. 12, 2016, which is based on and claims priority to Korean Patent Application No. 10-2015-0114948, filed on Aug. 13, 2015, in the Korean Intellectual Property Office, the disclosures of which are incorporated by reference herein in their entireties.

### BACKGROUND

### 1. Field

Methods and apparatuses consistent with exemplary embodiments broadly relate to a network connecting device, a central management server, and a network connecting method.

### 2. Description of Related Art

Related art network environments of general homes may have been connected to pharming sites through a sharing device, PC hacking, or infection of malware to lose money, or may have been exposed to additional risks of financial transactions because of exposure of certificates or personal information.

The existing security products for solving the problems, for example, vaccines or firewalls, focus on detecting or blocking infection of malware.

However, the detection and blocking of malware has limits because of a huge number of their varieties, and the malware is detected or treated after damage is generated.

The above information is presented as background information only to assist with an understanding of the present disclosure. No determination has been made, and no assertion is made, as to whether any of the above might be applicable as prior art with regard to the present disclosure.

### SUMMARY

In an effort to provide a network connecting device, a central management server, and a network connecting method for, when receiving a domain name server (DNS) query from an infected user terminal, blocking a connection to a forged and falsified domain name server (DNS), and detouring to a reliable domain name server (DNS).

According to one or more exemplary embodiments, a network connecting device connected to a user terminal and a network are provided, including: a forgery and falsification detector for changing a destination IP address of a domain name server (DNS) query received from the user terminal with an IP address of a DNS that is known in advance and is reliable; and a network connector for transmitting a DNS query including an IP address of the reliable DNS to the network.

The forgery and falsification detector may test a destination IP address of the domain name server (DNS) query to determine whether the destination IP address is the IP address of the reliable DNS, and if not, it may change the destination IP address to the IP address of the reliable DNS.

The forgery and falsification detector may transmit transmission information of the domain name server (DNS) query to a central management server after the network connector transmits the domain name server (DNS) query.

The network connector may transmit the transmission information provided by the forgery and falsification detector to the central management server through encrypted communication.

The forgery and falsification detector may transmit transmission information including a transaction ID, a query name, and a source port of the domain name server (DNS) query to the central management server.

The forgery and falsification detector may generate the transmission information as hash information, and may transmit the same to the central management server.

The forgery and falsification detector may determine whether the domain name server (DNS) query is normally transmitted to the reliable domain name server (DNS) from the central management server, and if not normally transmitted, it may block access to the network by the user terminal.

The forgery and falsification detector may detour a hypertext transfer protocol (HTP) request provided by the user terminal, and may transmit, to the user terminal, a notice page which indicates that the IP address of the DNS is forged and/or falsified, in response to the HTP request.

The network connecting device may further include a terminal access unit or interface connected to the user terminal through a cable to transmit and receive data, receiving the domain name server (DNS) query, and outputting the same to the forgery and falsification detector. The network connector may be connected to the network through a cable or may be connected to a network access device accessing the network through a cable.

The network connecting device may further include a terminal access unit or interface connected to the user terminal through a cable to transmit and receive data, receiving the domain name server (DNS) query, and outputting the same to the forgery and falsification detector. The network connector may be connected to a network access device accessing the network through wireless communication.

The network connecting device may further include a terminal access unit or interface connected to the user terminal in a wireless manner to transmit and receive data, receiving the domain name server (DNS) query, and outputting the same to the forgery and falsification detector. The network connector may be connected to a network access device accessing the network through wireless communication.

The network connecting device may further include: a memory which is an encrypted storage space; and a memory access controller which, when receiving a protocol request packet including a request, from the user terminal, to access to the memory, determining whether an URL and a destination IP address included in the protocol request packet correspond to a reliable normal web site, and when they correspond to the same, approving the request to access the memory.

The network connecting device may be realized as a small portable device.

The network connecting device may be realized as an additional configuration of a network access device for allowing access to the network.

According to another aspect of an exemplary embodiment, a central management server includes: a collector collecting information of a domain name server (DNS) query packet received by a reliable domain name server (DNS); a controller receiving transmission information of a domain name server (DNS) query from a network connecting device connected to a user terminal through wired or wireless communication, and comparing the collected information and the transmission information to determine whether a domain name server (DNS) query packet transmitted by the network connecting device is normally received by a reliable domain name server (DNS); and a communicator for receiving transmission information of the domain name server (DNS) query from the network connecting device, transmitting the same to the controller, and notifying the network connecting device of a determination result by the controller.

The reliable domain name server (DNS) may be connected to a test access port (TAP) device for monitoring traffic on a communication path, and the collector may collect information of the domain name server (DNS) query packet from the TAP device.

The communicator may perform encrypted communication with the network connecting device to receive transmission information including a transaction ID, a query name, and a source port of the domain name server (DNS) query.

Yet according to another aspect of one or more exemplary embodiments, a network connecting method of a network connecting device connected to a user terminal and a network, including: allowing the network connecting device to receive a domain name server (DNS) query from the user terminal; and transmitting the domain name server (DNS) query to an IP address of a domain name server (DNS) that is known in advance and is reliable, through the network.

The network connecting method may further include: testing a destination IP address of the domain name server (DNS) query; determining whether the destination IP address is the IP address of the reliable domain name server (DNS); and when the IP address is not the IP address of the reliable domain name server (DNS), changing the destination IP address to the IP address of the reliable domain name server (DNS).

The network connecting method may further include, after the transmitting through the network: transmitting transmission information of the domain name server (DNS) query to a central management server; determining whether the domain name server (DNS) query is normally transmitted to the reliable domain name server (DNS) from the central management server; and when determined as not normally transmitted, blocking the user terminal from access to the network.

The blocking may include detouring a hypertext transfer protocol (HTP) request received from the user terminal, and transmitting a notice page or a message to the user terminal indicating that the IP address of the domain name server (DNS) is forged and falsified, in response to the HTP request.

The network connecting method may further include, after the blocking: receiving, from the user terminal, a protocol request packet including a request for access to a memory that is an encrypted storage space; determining whether an URL and a destination IP address of the protocol request packet correspond to a reliable normal web site; and when they correspond to the normal web site, approving the request for access to the memory, and when they do not correspond to the normal web site, disapproving the request for access to the memory.

According to one or more exemplary embodiments, when a terminal attempting to access the network is infected by malware and receives a falsified domain name server (DNS) query, the terminal is detected and is detoured to a normal domain name server (DNS) to thus lead to access to the normal site and thereby provide a secure financial transaction environment.

Further, as a method for accessing important information stored in the encryption-applied secure space, it is determined whether there is access to a normal site, thereby approving the access, so important information is prevented from being leaked.

### BRIEF DESCRIPTION OF THE DRAWINGS

The above and other aspects, features, and advantages of various embodiments of the present disclosure will be more apparent from the following description taken in conjunction with the accompanying drawings, in which:

FIG. 1 is a block diagram illustrating a network connecting system according to an exemplary embodiment.

FIG. 2 is a block diagram illustrating a network connecting system according to another exemplary embodiment.

FIG. 3 is a view illustrating a connection configuration of a network connecting device to a peripheral device according to an exemplary embodiment.

FIG. 4 is a block diagram illustrating an internal configuration of a network connecting device according to an exemplary embodiment.

FIG. 5 is a block diagram illustrating an internal configuration of a central management server according to an exemplary embodiment.

FIG. 6 is a flow diagram illustrating a network connecting method according to an exemplary embodiment.

FIG. 7 is a flow diagram illustrating a network connecting method according to another exemplary embodiment.

FIG. 8 is a flow diagram illustrating a network connecting method according to another exemplary embodiment.

FIG. 9 is a flowchart illustrating a network connecting method according to another exemplary embodiment.

### DETAILED DESCRIPTION OF EXEMPLARY EMBODIMENTS

In the following detailed description, only certain exemplary embodiments have been shown and described, simply by way of illustration. As those skilled in the art would realize, the described exemplary embodiments may be modified in various different ways, all without departing from the spirit or scope of the present disclosure. Accordingly, the drawings and description are to be regarded as illustrative in nature and not restrictive, and like reference numerals designate like elements throughout the specification.

Unless explicitly described to the contrary, the word “comprise” and variations such as “comprises” or “comprising” will be understood to imply the inclusion of stated elements but not the exclusion of any other elements.

The suffixes “-er” and “-or” and the term “module” described in the specification mean units for processing at least one function and operation, and can be implemented by hardware or software and combinations thereof.

A network connecting device, a central management server, and a network connecting method according to an exemplary embodiment will now be described in detail with reference to accompanying drawings.

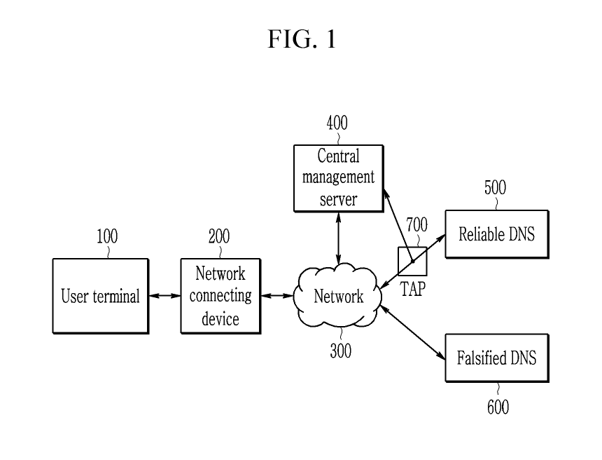

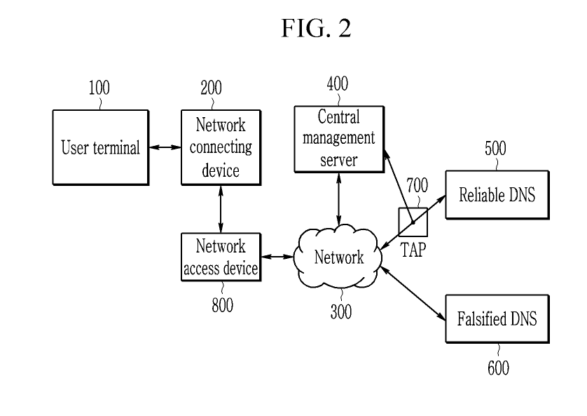

FIG. 1 is a block diagram illustrating a network connecting system according to an exemplary embodiment, and FIG. 2 is a block diagram illustrating a network connecting system according to another exemplary embodiment.

Referring to FIG. 1 and FIG. 2, a user terminal 100 is connected to a network connecting device 200 in a wired or wireless manner.

The network connecting device 200 is connected to a network 300, as shown in FIG. 1, or it is connected to the network 300 through a network access device 800, as shown in FIG. 2.

The user terminal 100 may be a terminal such as a laptop or a PC. The user terminal 100 transmits a domain name server (DNS) query so as to access a network site such as a financial transaction site.

The network connecting device 200 changes a destination IP address of the domain name server (DNS) query provided by the user terminal 100 to a destination IP address of a domain name server (DNS) 500 that is known in advance and is reliable. The network connecting device 200 transmits the changed domain name server (DNS) query to the network 300.

In another way, when receiving a domain name server (DNS) query from the user terminal 100, the network connecting device 200 tests a destination IP address of the domain name server (DNS) query. When the destination IP address is not an IP address of the known and reliable domain name server (DNS), the network connecting device 200 changes the destination IP address to the IP address of the reliable domain name server (DNS). The network connecting device 200 transmits the changed domain name server (DNS) query to the network 300.

The network 300 is connected to a central management server 400, at least one reliable domain name server (DNS) 500, and a falsified domain name server (DNS) 600. When the user terminal 100 is infected by malware to transmit the domain name server (DNS) query to the falsified domain name server (DNS) 600, the network connecting device 200 changes the destination IP address to the address of the reliable domain name server (DNS), so the connection to the domain name server (DNS) may be blocked.

The central management server 400 is a configuration for preventing the domain name server (DNS) query from being intercepted by the network device after the network connecting device 200 changes the destination IP address. That is, the central management server 400 monitors traffic of the reliable domain name server (DNS) on a communication path through a test access port (TAP) device 700. The central management server 400 determines whether the domain name server (DNS) query transmitted by the network connecting device 200 is normally transmitted to the domain name server (DNS) 500. The central management server 400 transmits a determination result to the network connecting device 200.

The network connecting device 200 determines a network access state of the user terminal 100 according to the determination result.

The network connecting device 200 may be realized as a small portable device, or it may be realized as an additional configuration of a network access device (not shown). According to an exemplary embodiment, the network access device 800, shown in FIG. 2, may be a network device such as an L1/L2/L3 switch, an access point (AP), or a network modem.

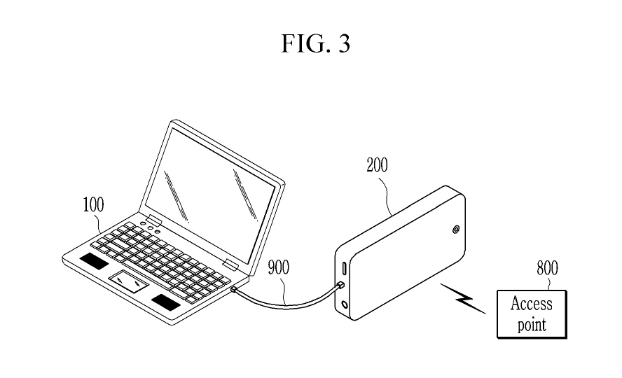

FIG. 3 is a view illustrating a connection configuration of a network connecting device to a peripheral device according to an exemplary embodiment.

Referring to FIG. 3, the network connecting device 200 is connected to the user terminal 100 through a cable 900, and is connected to the access point 800 in a wireless manner. In the wireless case, it may follow a wireless local area network (LAN) standard such as the wireless fidelity (WiFi).

Further, the cable may be an unshielded twisted pair (UTP) cable or a universal serial bus (USB) cable.

The network connecting device 200 may be connected to the user terminal 100 through a cable 900 including a UTP cable or a USB cable, and it may be connected to the access point 800 through a cable 900 including a UTP cable.

The network connecting device 200 may be connected to the user terminal 100 through a local area network (LAN), and it may be connected to the access point 800 through a wireless LAN (WLAN).

For example, the network connecting device 200 may be connected to the user terminal 100 through a UTP cable, and it may be connected to the access point 800 through a UTP cable.

In another way, the network connecting device 200 may be connected to the user terminal 100 through a USB cable, and it may be connected to the access point 800 through a WiFi connection.

In another way, the network connecting device 200 may be connected to the user terminal 100 through a UTP cable, and it may be connected to the access point 800 through a WiFi connection.

In another way, the network connecting device 200 may be connected to the user terminal 100 through a WiFi connection, and it may be connected to the access point 800 through a WiFi connection.

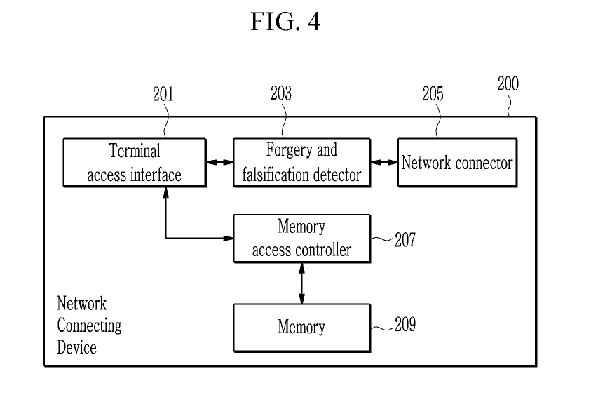

FIG. 4 is a block diagram illustrating an internal configuration of a network connecting device according to an exemplary embodiment.

Referring to FIG. 4, the network connecting device 200 includes a terminal access interface 201, a forgery and falsification detector 203, a network connector 205, a memory access controller 207, and a memory 209.

The terminal access interface 201 is connected to the user terminal 100 through a cable or a wireless LAN to transmit/receive data, receives a domain name server (DNS) query, and outputs the same to the forgery and falsification detector 203.

When receiving the domain name server (DNS) query from the user terminal 100, the forgery and falsification detector 203 changes the same to an IP address of the domain name server (DNS) that is known in advance and is reliable.

In this instance, the forgery and falsification detector 203 may test the destination IP address of the domain name server (DNS) query provided by the user terminal 100 to determine whether the destination IP address is an IP address of the reliable domain name server (DNS), and if not, it may change the destination IP address to the IP address of the reliable domain name server (DNS) 500.

The forgery and falsification detector 203 transmits transmission information of the domain name server (DNS) query to the central management server 400 after the network connector 205 transmits the domain name server (DNS) query. In this instance, the forgery and falsification detector 203 may transmit transmission information including a transaction identifier (ID), a query name, and a source port of the domain name server (DNS) query.

The forgery and falsification detector 203 may generate the transmission information to be hash information, and may transmit the same to the central management server 400.

The forgery and falsification detector 203 determines whether the domain name server (DNS) query is normally transmitted to the reliable domain name server (DNS) 500 from the central management server 400. If not normally transmitted, the forgery and falsification detector 203 blocks the access to the network by the user terminal 100.

The forgery and falsification detector 203 detours a hypertext transfer protocol (HTTP) request provided by the user terminal 100. The forgery and falsification detector 203 transmits a notice page for notifying that the IP address of the domain name server (DNS) is forged and falsified to the user terminal 100 in response to the hypertext transfer protocol (HTTP) request.

The network connector 205 transmits the domain name server (DNS) query including the IP address of the reliable domain name server (DNS) 500 to the network 300.

The network connector 205 is connected to the central management server 400 through encrypted communication, and transmits transmission information of the domain name server (DNS) query provided by the forgery and falsification detector 203 to the central management server 400.

When receiving, from the user terminal 100, a transmission control protocol (TCP) or user datagram protocol (UDP) request packet including an access request by the terminal access interface 201, the memory access controller 207 determines whether a URL and a destination IP address of the request packet correspond to the reliable normal web site. When they correspond to the normal web site, the memory access controller 207 approves the request for access to the memory 209. It may be determined whether they correspond to a normal web site by determining whether the destination IP address included in the request packet matches the IP address that corresponds to the URL acquired from the reliable domain name server (DNS) 500.

The memory 209 forms an encrypted storage space.

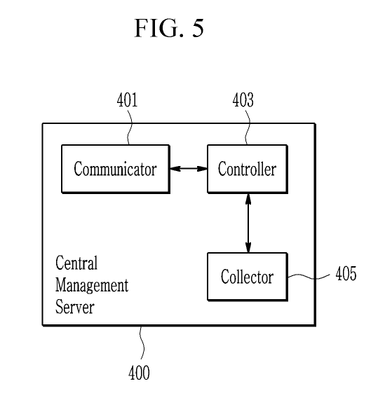

FIG. 5 is a block diagram illustrating an internal configuration of a central management server according to an exemplary embodiment.

Referring to FIG. 5, the central management server 400 includes a communicator 401, a controller 403, and a collector 405, according to an exemplary embodiment.

The communicator 401 is connected to the network connecting device 200 through an encryption channel. The communicator 401 receives transmission information of the domain name server (DNS) query from the network connecting device 200 and transmits the same to the controller 403. The communicator 401 notifies the network connecting device 200 of a result of a determination by the controller 403.

The controller 403 receives transmission information of the domain name server (DNS) query from the network connecting device 200. Here, the transmission information may include a transaction ID, a query name, and a source port of the domain name server (DNS) query.

The controller 403 compares information collected from the reliable domain name server (DNS) 500 by the collector 405 and transmission information received from the network connecting device 200 to determine whether the domain name server (DNS) query packet transmitted by the network connecting device 200 is normally provided to the reliable domain name server (DNS) 500.

The collector 405 collects information of the domain name server (DNS) query packet transmitted to the reliable domain name server (DNS) 500 through the TAP device (700 of FIG. 1) which is connected to the reliable domain name server (DNS) 500 and which monitors traffic on the communication path.

A network connecting method, according to an exemplary embodiment, will now be described based on the above-described configuration.

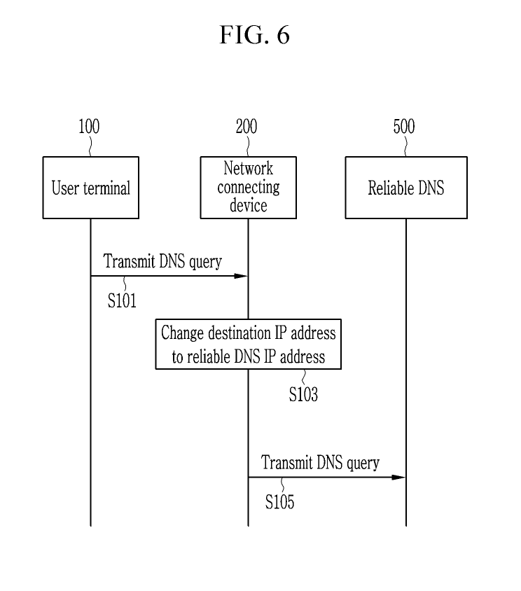

FIG. 6 is a flowchart illustrating a network connecting method according to an exemplary embodiment.

Referring to FIG. 6, the user terminal 100 transmits a domain name server (DNS) query to the network connecting device 200 (in operation S101).

The network connecting device 200 changes a destination IP address of the domain name server (DNS) query received in operation S101 to an IP address of the domain name server (DNS) 500 that is known in advance and is reliable (in operation S103).

The network connecting device 200 transmits the domain name server (DNS) query with the destination IP address that is changed in operation S103 to the reliable domain name server (DNS) 500 (in operation S105).

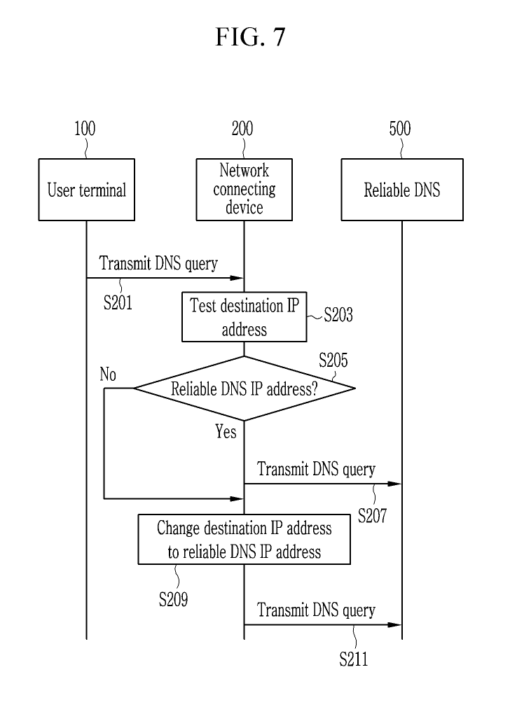

FIG. 7 is a flowchart illustrating a network connecting method according to another exemplary embodiment.

Referring to FIG. 7, the user terminal 100 transmits a domain name server (DNS) query to the network connecting device 200 (in operation S201).

The network connecting device 200 tests the destination IP address of the domain name server (DNS) query (in operation S203). The network connecting device 200 determines whether the destination IP address is an IP address of the reliable domain name server (DNS) 500 (in operation S205).

In this instance, when the destination IP address is an IP address of the reliable domain name server (DNS) 500, the network connecting device 200 transmits the domain name server (DNS) query received in operation S201 to the reliable domain name server (DNS) 500 (in operation S207).

When the destination IP address is not an IP address of the reliable domain name server (DNS) 500, the network connecting device 200 changes the destination IP address of the domain name server (DNS) query to an IP address of the reliable domain name server (DNS) 500 (in operation S209). The network connecting device 200 transmits the domain name server (DNS) query including the changed IP address to the reliable domain name server (DNS) 500 through the network 300 (in operation S211).

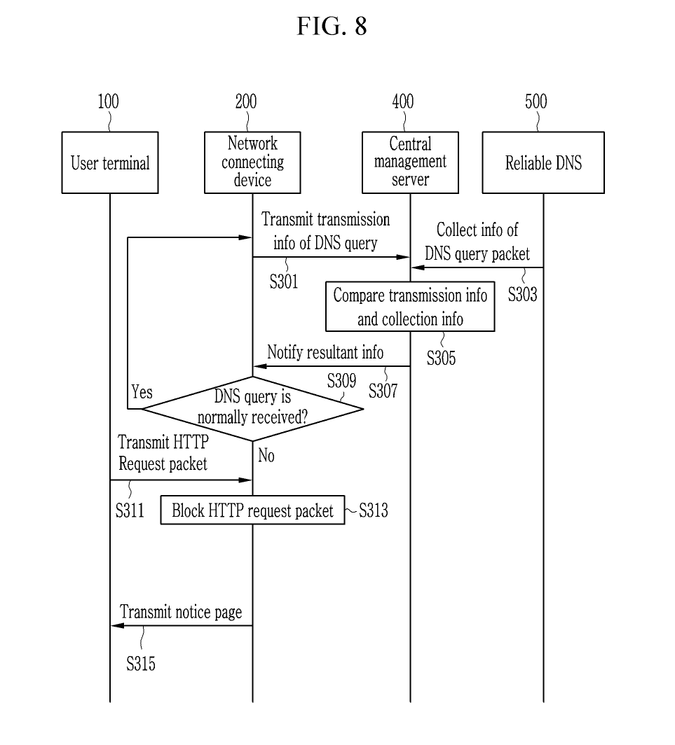

FIG. 8 is a flowchart illustrating a network connecting method according to another exemplary embodiment.

Referring to FIG. 8, the network connecting device 200 transmits transmission information of the domain name server (DNS) query to the central management server 400 (in operation S301).

The central management server 400 collects information of the domain name server (DNS) query packet from the reliable domain name server (DNS) 500 (in operation S303).

The central management server 400 compares the transmission information received in operation S301 and the information collected in operation S303 (in operation S305), and transmits comparison result information to the network connecting device 200 (in operation S307).

The network connecting device 200 determines whether the domain name server (DNS) query is normally received by the reliable domain name server (DNS) based on the result information received in operation S307 (in operation S309).

In this instance, when normally received, the method returns to operation S301.

When not normally received, the network connecting device 200 determines that forgery and falsification have occurred such as the domain name server (DNS) query having been intercepted by a network device. Therefore, when receiving a hypertext transfer protocol (HTTP) request packet from the user terminal 100 (in operation S311), the network connecting device 200 blocks the request packet (in operation S313). The network connecting device 200 transmits a notice page for notifying that forgery and falsification have occurred to the user terminal 100 (in operation S315).

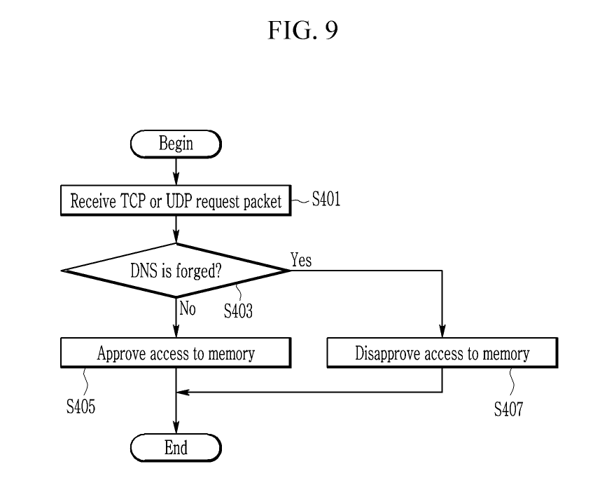

FIG. 9 is a flowchart illustrating a network connecting method according to another exemplary embodiment, particularly showing an operation of a memory access controller such as the memory access controller 207 depicted in FIG. 4.

Referring to FIG. 9, when receiving a UDP request packet or a TCP request packet (in operation S401), the memory access controller 207 determines whether the domain name server (DNS) is forged (in operation S403). That is, the memory access controller 207 determines whether the IP address of the domain name server (DNS) is determined to be forged and falsified, for example as described above with reference to FIG. 7 and FIG. 8.

For example, when an URL address of www.AA.com is input on a web browser of the user terminal 100 in order to access 00 Bank, the transmitted packet includes URL information of www.AA.com and a destination IP address. In this instance, the pair of the URL and the destination IP is determined to be valid. In the case of a foreign IP when accessing a domestic bank site, the IP is not an IP to which the normal DNS has responded but a different IP, so this is determined to be a forged and falsified case.

In this instance, when not forged and falsified, access to the memory 209 by the UDP request packet or the TCP request packet is approved (in operation S405). That is, when the UDP request packet or the TCP request packet requests to read a certificate, it is approved to read the certificate stored in the memory 209.

When forged and falsified, access to the memory 209 is disapproved (in operation S407).

The above-described exemplary embodiments can be realized through a program for realizing functions corresponding to the configuration of exemplary embodiments or a recording medium for recording the program in addition to through the above-described device and/or method, which is easily realized by a person skilled in the art.

While the present disclosure has been described in connection with what is presently considered to be practical exemplary embodiments, it is to be understood that the present disclosure is not limited to exemplary embodiments, but, on the contrary, is intended to cover various modifications and equivalent arrangements included within the spirit and scope of the appended claims and their equivalents.

1-22. (canceled)

23. A network connecting device comprising:
a forgery and falsification detector which changes a destination IP address provided in a domain name server (DNS) query received from a user terminal with an IP address of a DNS that is known in advance and is reliable; and
a network connector which transmits the DNS query comprising the IP address of the reliable DNS to a network.

24. The network connecting device of claim 23, wherein:
the forgery and falsification detector tests the destination IP address provided in the DNS query to determine whether the destination IP address is the IP address of the reliable DNS, and
in response to the forgery and falsification detector determining that the destination IP address is not the IP address, the forgery and falsification detector changes the destination IP address to the IP address of the reliable DNS.

25. The network connecting device of claim 24, wherein
the forgery and falsification detector transmits, via the network connector, transmission information of the DNS query to a central management server, after the network connector transmits the DNS query to the network.

26. The network connecting device of claim 25, wherein
the network connector transmits the transmission information provided by the forgery and falsification detector to the central management server through an encrypted communication.

27. The network connecting device of claim 26, wherein
the forgery and falsification detector transmits, via the network connector, the transmission information comprising a transaction identifier (ID), a query name, and a source port of the DNS query to the central management server.

28. The network connecting device of claim 27, wherein
the forgery and falsification detector generates the transmission information as hash information and transmits, via the network connector, the hash information to the central management server.

29. The network connecting device of claim 25, wherein
the forgery and falsification detector determines whether the DNS query is normally transmitted to the reliable DNS from the central management server, and
in response to the forgery and falsification detector determining that the DNS query is not normally transmitted to the reliable DNS, the forgery and falsification detector blocks the user terminal from access to the network.

30. The network connecting device of claim 29, wherein
the forgery and falsification detector detours a hypertext transfer protocol request provided by the user terminal, and transmits a notice page for notifying that the IP address of the DNS is forged and falsified to the user terminal in response to the hypertext transfer protocol request.

31. The network connecting device of claim 24, further comprising
a terminal access interface connected to the user terminal through a cable, which transmits and receives data comprising the DNS query, and which outputs the received DNS query to the forgery and falsification detector,
wherein the network connector is connected to the network through a cable or is connected to a network access device accessing the network through the cable.

32. The network connecting device of claim 24, further comprising
a terminal access interface connected to the user terminal through a cable, which transmits and receives data comprising the DNS query, and which outputs the received DNS query to the forgery and falsification detector,
wherein the network connector is connected to a network access device accessing the network through a wireless communication.

33. The network connecting device of claim 24, further comprising
a terminal access interface connected to the user terminal in a wireless manner, which transmits and receives data comprising the DNS query, and outputs the received DNS query to the forgery and falsification detector,
wherein the network connector is connected to a network access device accessing the network through a wireless communication.

34. The network connecting device of claim 24, further comprising:
a memory which is an encrypted storage space; and
a memory access controller which, when receiving, from the user terminal, a protocol request packet comprising a request for access to the memory, determines whether a uniform resource locator (URL) and the destination IP address provided in a protocol request packet correspond to a reliable normal web site, and when the URL and the destination IP address correspond to the reliable web site, approves the request for access to the memory.

35. The network connecting device of claim 23, wherein
the network connecting device is realized as a small portable device.

36. The network connecting device of claim 23, wherein
the network connecting device is realized as an additional configuration of a network access device which allows the user terminal to access the network.

37. A central management server comprising:
a collector which collects information of a domain name server (DNS) query packet received by a reliable DNS;
a controller which receives transmission information of the DNS query from a network connecting device connected to a user terminal through wired or wireless communication, and which compares the information, collected by the collector, with the transmission information to determine whether the DNS query packet is received by the reliable DNS; and
a communicator which receives the transmission information of the DNS query packet from the network connecting device, which transmits the transmission information to the controller, and which notifies the network connecting device of a determination result by the controller.

38. The central management server of claim 37, wherein
the reliable DNS is connected to a test access port (TAP) device which monitors traffic on a communication path, and
the collector collects information of the DNS query packet from the TAP device.

39. The central management server of claim 37, wherein
the communicator performs encrypted communication with the network connecting device to receive the transmission information comprising a transaction ID, a query name, and a source port of the DNS query packet.

40. A method of a network connecting device connecting a user terminal to a network, comprising:
receiving a domain name server (DNS) query from the user terminal; and
transmitting, via the network, the domain name server DNS query to an IP address of a DNS that is known in advance and is reliable.

41. The network connecting method of claim 40, further comprising:
testing a destination IP address of the DNS query;
determining whether the destination IP address is the IP address of the reliable DNS; and
in response to the destination IP address being not the IP address of the reliable DNS, changing the destination IP address to the IP address of the reliable DNS.

42. The network connecting method of claim 40, further comprising:
after the transmitting the DNS query through the network:
transmitting transmission information of the DNS query to a central management server;
determining whether the DNS query is normally transmitted to the reliable DNS from the central management server; and
in response to the determining that the DNS query is not normally transmitted, blocking access of the user terminal to the network.

43. The network connecting method of claim 42, wherein the blocking comprises
detouring a hypertext transfer protocol (HTP) request received from the user terminal, and transmitting, to the user terminal, a message to be output on the user terminal which indicates that an IP address of the DNS is forged, in response to the HTP request.

44. The network connecting method of claim 43, further comprising:
after the blocking:
receiving, from the user terminal, a protocol request packet comprising a request for access to a memory that is an encrypted storage space;
determining whether a uniform resource locator (URL) and a destination IP address of the protocol request packet correspond to a reliable normal web site; and
in response to the determining indicating that the URL and the destination IP address correspond to the normal web site, approving the request for access to the memory, and
in response to the determining indicating that the URL and the destination IP address do not correspond to the normal web site, disapproving the request for access to the memory.
